(19) United States
(12) Patent Application Publication
(10) Pub. No.: US 2007/0183698 A1
(43) Pub. Date: Aug. 9, 2007

(54) FLUID DYNAMIC BEARING, SPINDLE MOTOR, DISK DRIVE, AND MANUFACTURING METHOD OF FLUID DYNAMIC BEARING

(75) Inventor: Yasuaki Hada, Kyoto (JP)

Correspondence Address: NIDEC CORPORATION;c/o KEATING & BENNETT, LLP, 8180 GREENSBORO DRIVE, SUITE 850, MCLEAN, VA, 22102, US

(73) Assignee: NIDEC CORPORATION, Kyoto (JP)

(21) Appl. No.: 11/672,219

(22) Filed: Feb. 7, 2007

(30) Foreign Application Priority Data
Feb. 8, 2006 (JP) 2006-030571

(51) Int. Cl. F16C 32/06

(52) U.S. Cl. 384/107

(57) ABSTRACT

A fluid dynamic bearing includes a sleeve, a shaft arranged inside the sleeve with a gap interposed therebetween, and a hollow cylindrical bearing housing having a closed end and an open end. The bearing housing is arranged outside the sleeve and has a flange having a thrust bearing surface. A plurality of dynamic pressure generating grooves are formed on the thrust bearing surface. A flat region surrounding the dynamic pressure generating grooves is formed on the thrust bearing surface at and along an outer peripheral edge of the thrust bearing surface.

### BACKGROUND OF THE INVENTION

1. Field of the Invention

The present invention relates to a fluid dynamic bearing. More particularly, the present invention relates to a fluid dynamic bearing including a thrust dynamic bearing portion, and a spindle motor and a disk drive that include the same, and a fabrication method of the fluid dynamic bearing.

2. Description of the Related Art

Disk drives such as hard disk drives include a spindle motor for rotating a disk-shaped storage medium (hereinafter, simply referred to as a disk). The spindle motor includes a base plate, a ring-shaped stator which is secured to the base plate and around which a stator coil is wound, a rotor accommodated inside the stator and having a rotor magnet, and a bearing for supporting the rotor in a rotatable manner relative to the base plate. A fluid dynamic bearing is used as the bearing of the spindle motor in order to achieve high-speed, low-vibration, and low-noise operation.

The fluid dynamic bearing includes an approximately cup-shaped bearing housing secured to the base plate, a sleeve that is hollow and is arranged inside the bearing housing, a shaft arranged inside the sleeve to be rotatable together with the rotor, and lubricating fluid with which gaps between respective components are filled, for example.

In an exemplary fluid dynamic bearing, a thrust dynamic bearing portion is provided on a surface of the bearing housing facing the rotor. More specifically, the bearing housing includes a ring-shaped flange at its rotor-side end along its outer peripheral edge. A plurality of first dynamic pressure generating grooves defining the thrust dynamic bearing portion are formed on an upper surface of the flange. On an inner circumferential surface of the sleeve are arranged a plurality of second dynamic pressure generating grooves forming a radial dynamic bearing portion. The fluid dynamic bearing having the aforementioned structure supports the rotor in a rotatable manner.

When the bearing housing of the above fluid dynamic bearing is manufactured by pressing, an intermediate form of the bearing housing is formed from a base material by the pressing operation. The intermediate form includes not only the bearing housing but also an extraneous portion. The first dynamic pressure generating grooves are also formed on the upper surface of the bearing housing in the intermediate form. Then, the extraneous portion is separated from the bearing housing by punching, there by obtaining the bearing housing.

However, the first dynamic pressure generating grooves are formed on the upper surface of the bearing housing in the intermediate form, and it is therefore difficult to hold the intermediate form at side surfaces and bottom surfaces of the first dynamic pressure generating grooves with jigs. Thus, large burrs may be generated in the side surfaces and the bottom surfaces of the first dynamic pressure generating grooves when the bearing housing is punched out from the intermediate form. The burrs generated in radial outer portions of the first dynamic pressure generating grooves may interfere with the supply and circulation of the lubricating fluid and lower the bearing characteristics.

Moreover, in a case where the intermediate form is cut in a downward direction, the side surfaces and the bottom surfaces of the first dynamic pressure generating grooves are also deformed in a downward direction. Thus, a depth of the respective groove becomes larger in a radially outer direction. Consequently, the dimensions of the upper surface of the bearing housing, which serves as a thrust dynamic bearing, are changed. For this reason, bearing characteristics are varied between products.

Furthermore, when the bearing housing is punched out from the intermediate form, a pressing force is applied around a cut portion of the respective first dynamic pressure generating groove. This pressing force may cause deformation of the first dynamic pressure generating groove, thus varying the bearing characteristics between products.

### SUMMARY OF THE INVENTION

In order to overcome the problems described above, preferred embodiments of the present invention provide a fluid dynamic bearing including a first member, a second member rotatable relative to the first member, a radial dynamic bearing and a thrust dynamic bearing supporting the first and second members in a rotatable manner relative to each other, and lubricating fluid retained in the radial dynamic bearing and the thrust dynamic bearing.

The first and second members include thrust bearing surfaces, respectively. The thrust bearing surfaces define the thrust dynamic bearing and are opposed to each other with a thrust gap interposed therebetween.

One of the thrust bearing surfaces has a plurality of dynamic pressure generating grooves generating a dynamic pressure in the lubricating fluid in the thrust gap during relative rotation of one of the first and second members to the other.

A flat region is arranged at an outer peripheral edge of one of the thrust bearing surfaces. A distance between the opposed thrust bearing surfaces is larger in the flat region than in a remaining region of the one thrust bearing surface.

As described above, in a conventional fluid dynamic bearing, the dynamic pressure generating grooves are arranged at the outer peripheral edge of the thrust bearing surface. Therefore, the grooves cannot be held during the punching step, thus causing generation of burrs in radial outer regions of the dynamic pressure generating grooves or deforming of the grooves.

However, in the fluid dynamic bearing according to the preferred embodiments of the present invention, the flat region is arranged at and along the outer peripheral edge of the thrust bearing surface. Therefore, a portion to be cut can be held over its entire peripheral length when punching is carried out. Accordingly, generation of burrs in the dynamic pressure generating grooves and deforming of the dynamic pressure generating grooves during punching can be prevented as compared with the conventional technique, and it is possible to prevent the lowering of the bearing performance and make the bearing performance more stable.

Other features, elements, steps, advantages and characteristics of the present invention will become more apparent from the following detailed description of preferred embodiments thereof with reference to the attached drawings.

### BRIEF DESCRIPTION OF THE DRAWINGS

FIG. 1 is a vertical cross-sectional view of a disk drive according to a first preferred embodiment of the present invention.

FIG. 2 is a vertical cross-sectional view of a spindle motor according to the first preferred embodiment of the present invention.

FIG. 3 is a vertical cross-sectional view of a flange.

FIG. 4 is a plan view of the flange, when seen from above in an axial direction of the spindle motor.

FIG. 5 is avertical cross-sectional view of a spindle motor according to a second preferred embodiment of the present invention.

FIG. 6 is avertical cross-sectional view of a spindle motor according to a third preferred embodiment of the present invention.

FIG. 7 shows the steps of a manufacturing method of a bearing housing according to the first preferred embodiment of the present invention.

FIGS. 8A and 8B show a cutting step.

### DETAILED DESCRIPTION OF PREFERRED EMBODIMENTS

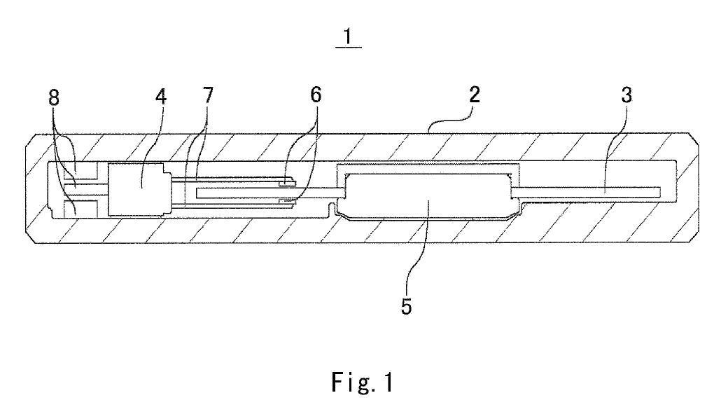

Referring to FIGS. 1 through 8B, preferred embodiments of the present invention will be described in detail. It should be noted that in the explanation of the present invention, when positional relationships among and orientations of the different components are described as being up/down or left/right, ultimate positional relationships and orientations that are in the drawings are indicated; positional relationships among and orientations of the components once having been assembled into an actual device are not indicated. Additionally, in the following description, an axial direction indicates a direction parallel to a rotation axis, and a radial direction indicates a direction perpendicular to the rotation axis.

### First Preferred Embodiment

FIG. 1 is a vertical cross-sectional view of a disk drive 1 according to a first preferred embodiment of the present invention. The disk drive 1 is, for example, a hard disk drive with reduced size and height for rotating a small disk-shaped storage medium (hereinafter, simply referred to as a disk), e.g., a single one-inch disk.

The disk drive 1 includes a housing 2 which accommodates other components of the disk drive 1, such as a disk 3, a magnetic head moving portion 4, and a spindle motor 5 therein.

The disk 3 is a disk-shaped member having a magnetic recording layer formed of magnetic material. Information can be magnetically recorded on the disk 3. A one-inch disk, for example, can be used as the disk 3, or any other suitable size may be used.

The magnetic head moving portion 4 includes a pair of magnetic heads 6, a pair of arms 7, and actuators 8. The magnetic head moving portion 4 carries out at least one of reading and recording of information from/on the disk 3.

Each of the magnetic heads 6 is provided at an end of an associated one of the arms 7. The magnetic heads 6 are adjacent to both surfaces of the disk 3, respectively, and record information on the magnetic recording layer of the disk 3 and read the information recorded in the magnetic recording layer. The arms 7 support the magnetic heads 6, respectively. The actuator 8 moves the associated one of the magnetic heads 6 relative to the disk 3 and supports another end of the associated one of the arms 7. That is, the actuator 8 pivotally moves the associated arm 7 to move the associated magnetic head 6 to a desired position on the disk 3.

The spindle motor 5 rotates the disk 3. Details of the spindle motor 5 are described next. Spindle motor

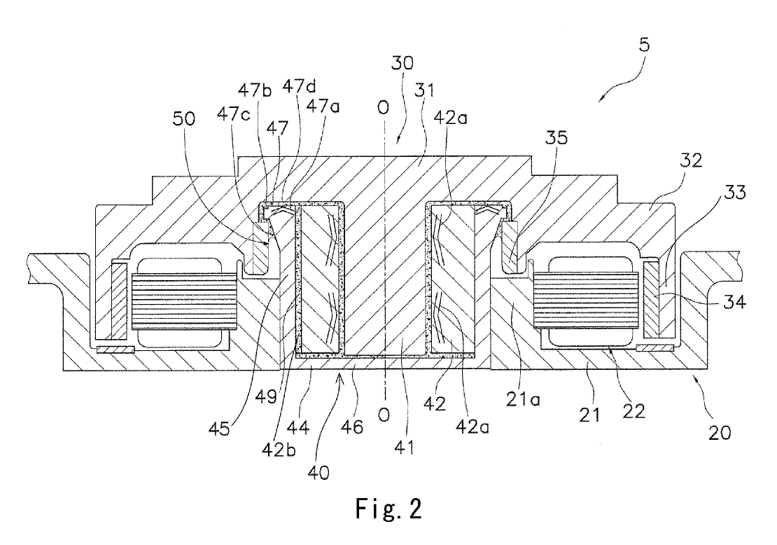

FIG. 2 is a vertical cross-sectional view of the spindle motor 5 according to the first preferred embodiment of the present invention. Line 0-0 in FIG. 2 shows a rotation axis of the spindle motor 5. In the description of the present preferred embodiment, “up” and “down” in FIG. 2 are defined as “up” and “down” with respect to the axial direction for the sake of convenience. However, this definition does not limit the orientation of the spindle motor 5 when the spindle motor 5 is actually attached to the disk drive 1.

The spindle motor 5 includes a base plate 20, a rotor 30, and a fluid dynamic bearing 40 as main components.

The base plate 20 forms a stationary portion of the spindle motor 5 and is secured to the aforementioned housing 2 of the disk drive 1. The base plate 20 includes a bracket 21 and a stator 22 as main components.

The bracket 21 is a ring-shapedmember forming a main portion of the base plate 20 and includes a portion 21a that is hollow and cylindrical and extends upward in the axial direction. The cylindrical portion 21a is arranged inside an inner circumference of the bracket 21. The stator 22 is secured to an outer circumference of the cylindrical portion 21a. The fluid dynamic bearing 40 that will be described later is secured to an inner circumference of the cylindrical portion 21a.

The rotor 30 includes a rotor hub 31, a disk-mounting portion 32, a wall 33, and a rotor magnet 34. The rotor hub 31 is a disk-shaped member and is preferably integral with a shaft 41 that will be described later. The disk-mounting portion 32 is arranged outside the rotor hub 31 in a radial direction perpendicular to the axial direction. The disk-mounting portion 32 is arranged at a lower level than the rotor hub 31 in the axial direction. A disk can be placed on the disk-mounting portion 32. In the present preferred embodiment, the rotor hub 31 and the disk-mounting portion 32 are integrally formed with each other.

A shaft-retaining ring 35 is secured at an inner periphery of the disk-mounting portion 32. An inner diameter of the shaft-retaining ring 35 is smaller than an outer diameter of a flange 47 of a bearing housing 44 that will be described later. With this arrangement, the rotor 30 can be prevented from detaching from the fluid dynamic bearing 40.

The wall 33 is formed axially below an outer peripheral edge of the disk-mounting portion 32 over an entire peripheral length of the disk-mounting portion 32. A ring-shaped rotor magnet 34 is secured to an inner surface of the wall 33 with, for example, adhesive. The rotor magnet 34 opposes the aforementioned stator 22 in the radial direction. The rotor magnet 34 and the stator 22 define a magnetic circuit. When a current flows through a coil of the stator 22, a rotating force is generated at the rotor magnet 34 and rotates the rotor 30.

The fluid dynamic bearing 40 supports the rotor 30 in a rotatable manner relative to the base plate 20. The fluid dynamic bearing 40 includes a bearing housing 44, a sleeve 42, and a shaft 41 as main components.

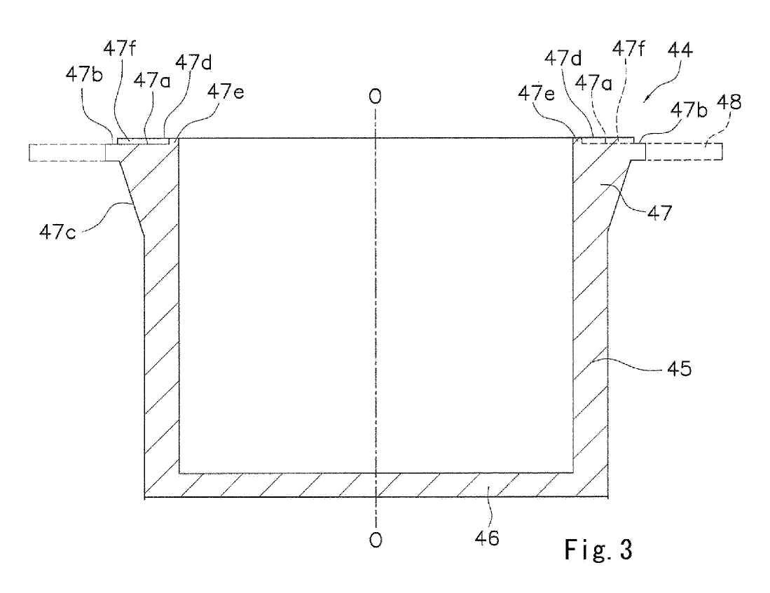

FIG. 3 is a vertical cross-sectional view of the bearing housing 44. The bearing housing 44 is hollow and cylindrical. One of the axial ends of the bearing housing 44 is open, while the other axial end is closed. That is, the bearing housing 44 is approximately cup-shaped. The bearing housing 44 includes a tube 45, a bottom portion 46, and a flange 47 all of which form a single component. The tube 45 is inserted into and secured to the cylindrical portion 21a. The bottom portion 46 is in the form of a circular plate arranged at an axial lower end of the tube 45, and closes the lower end of the tube 45.

The flange 47 is formed at a radial outer surface of an axial upper end of the tube 45, and is opposed to the rotor hub 31 with a small gap interposed therebetween, as shown in FIG. 2. On an axial upper surface of the flange 47, i.e., a thrust bearing surface 47d, are formed a plurality of first dynamic pressure generating grooves 47a.

The first dynamic pressure generating grooves 47a are preferably spiral grooves having a shape that pumps the lubricating fluid from radially outward to radially inward, for example, and are circumferentially regularly arranged. The flange 47 has an inclined surface 47c on its outer circumference. The inclined surface 47c faces an inner circumferential surface of the shaft-retaining ring 35, as shown in FIG. 2. Details of the flange 47 will be described later.

The sleeve 42 is hollow and elongated in the axial direction and is included in a stationary portion of the fluid dynamic bearing 40. The sleeve 42 is arranged inside the tube 45 of the bearing housing 44. As shown in FIG. 2, an axially extending groove 42b formed on the sleeve 42 and an inner surface of the tube 45 define a communication hole 49 extending in the axial direction. An axial lower end of the sleeve 42 is opposed to the bottom portion 46 with a small gap interposed therebetween.

On an inner peripheral surface of the sleeve 42 are formed the plurality of second dynamic pressure generating grooves 42a. The second dynamic pressure generating grooves 42a are preferably herringbone grooves having approximately a V-shape, for example, and are circumferentially regularly arranged. In the present preferred embodiment, the second dynamic pressure generating grooves 42a are circumferentially regularly arranged at two axial positions.

The shaft 41 is a cylindrical-shaped member included in a rotating portion of the fluid dynamic bearing 40 and is arranged inside the sleeve 42 in the radial direction. There is a small gap between the shaft 41 and the sleeve 42. An axial lower end of the shaft 41 is opposed to the bottom portion 46 with a small gap interposed therebetween. In the present preferred embodiment, the shaft 41 and the rotor hub 31 are integrally formed with each other. However, the shaft 41 and the rotor hub 31 may be formed separately from each other.

Small gaps are formed between the various components of the fluid dynamic bearing 40. The small gaps include the communication hole 49. All of the small gaps are in communication with each other and are continuously filled with lubricating fluid.

The gap between the inclined surface 47c of the flange 47 and the inner circumferential surface of the shaft-retaining ring 35 is tapered upwards. In this tapered gap, a good balance is achieved between a surface tension of the lubricating fluid, i.e., lubricating oil, retained in the gap and the outside atmospheric pressure, and an interface between the lubricating fluid and the ambient air has a meniscus shape. Therefore, a tapered sealing portion 50 serving as an oil reservoir is formed. For the tapered sealing portion 50, the position of the interface between the lubricating fluid and ambient air can be moved. Thus, a change in the volume of the lubricating fluid caused by thermal expansion can be absorbed by a space in the tapered sealing portion 50.

As described above, in the fluid dynamic bearing 40, the flange 47 having the first dynamic pressure generating grooves 47a, the rotor hub 31, and the lubricating fluid interposed between the flange 47 and the rotor hub 31 together define a thrust dynamic bearing portion that supports the rotor 30 in the axial direction. The sleeve 42 having the second dynamic pressure generating grooves 42a, the shaft 41, and the lubricating fluid interposed between the sleeve 42 and the shaft 41 together define a radial dynamic bearing portion that supports the rotor 30 in the radial direction.

The fluid dynamic bearing 40 according to this preferred embodiment includes a feature in the shape of the flange 47 in the thrust dynamic bearing portion. Details of the flange 47 are now described.

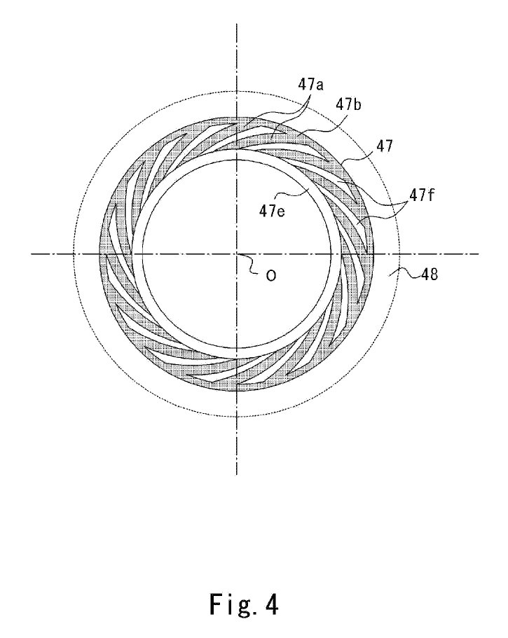

FIG. 3 is a vertical cross-sectional view of the bearing housing 44. FIG. 4 is a plan view of the flange 47 when seen from above in the axial direction.

Referring to FIG. 3, the flange 47 is arranged radially outside the axial upper end of the tube 45 of the bearing housing 44. The flange 47 is tapered downwards, that is, it has an outer diameter decreasing as it extends downward. A plurality of the first dynamic pressure generating grooves 47a and a flat region 47b are formed on the thrust bearing surface 47d of the flange 47. In the present preferred embodiment, the flat region 47b is ring-shaped.

The first dynamic pressure generating grooves 47a are, for example, spiral grooves having a shape that pumps the lubricating fluid from radially outward to radially inward, as shown in FIG. 4. The flat region 47b is arranged radially outside the first dynamic pressure generating groves 47a to surround the first dynamic pressure generating grooves 47a. More specifically, the ring-shaped flat region 47b is arranged at and along an outer peripheral edge of the flange 47 over an entire peripheral length of the flange 47. A distance between the flange 47 serving as the thrust bearing surface and the rotor hub 31 is larger in the flat region 47b than in a remaining portion of the thrust bearing surface 47d.

The flat region 47b lies in approximately the same plane as bottom surfaces of the first dynamic pressure generating grooves 47a in the present preferred embodiment. Therefore, the flat region 47b can be regarded as a portion of the first dynamic pressure generating grooves 47a, although the first dynamic pressure generating grooves 47a and the flat region 47b are described as separate components in order to clarify the structure of the flange 47 in the present preferred embodiment.

As shown in FIG. 4, a ring-shaped projection 47e projects upward in the axial direction from bottom surfaces of the first dynamic pressure generating grooves 47a to the thrust bearing surface 47d near an inner peripheral edge of the thrust bearing surface 47d. A plurality of raised portions 47f are arranged to extend from the projection 47e radially outwards. Each first dynamic pressure generating groove 47ais formed between the adjacent raised portions 47f. The flat region 47b is formed radially outside the raised portions 47f. An axial upper surface of the projection 47e and the upper surfaces of the raised portions 47f lie in approximately the same plane.

The first dynamic pressure generating grooves 47a and the flat region 47b are formed by pressing at the same time the bearing housing 44 is formed, as described later. In this pressing, an extraneous portion 48 that is ring-shaped is also formed radially outside the flange 47, as shown in FIG. 4. The extraneous portion 48 is not used as a portion of the bearing housing 44 and is separated from the flange 47 by being punched out after pressing. An axial upper surface of the extraneous portion 48 is continuous with the flat region 47b in approximately the same plane. Please note that the “extraneous portion 48” refers to the material for the flange 47 that is not used. Therefore, a boundary between the extraneous portion 48 and the flat region 47b of the flange 47 is not fixed until the flange 47 is cut from the extraneous portion 48.

Manufacturing Method of the Bearing Housing

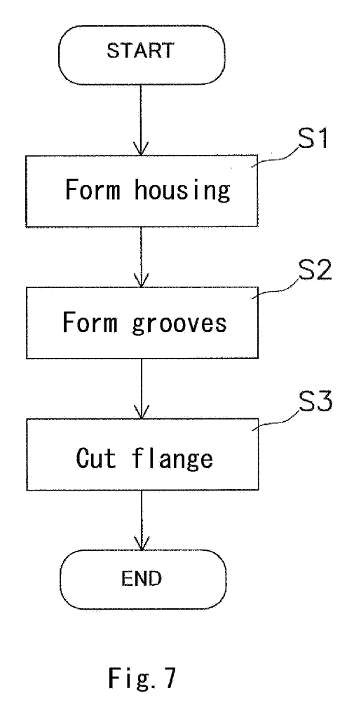

A method for manufacturing the bearing housing 44 of the fluid dynamic bearing 40 according to the first preferred embodiment will now be described. FIG. 7 shows steps of the manufacturing method of the bearing housing 44 according to the first preferred embodiment of the present invention. The details of the structure of the bearing housing 44 are shown in FIGS. 2 to 4. The manufacturing method of the housing bearing 44 includes a housing forming step S1, a groove forming step S2, and a cutting step S3.

In the housing forming step S1, an intermediate form of the bearing housing 44 is created. More specifically, the tube 45, the bottom plate 46, and the flange 47 are simultaneously formed from a plate-like member by cold pressing, for example. The intermediate form thus includes the extraneous portion 48 that is continuous with the flat region 47b of the flange 47 radially outside the flange 47 (see FIG. 3).

In the groove forming step S2, the plurality of first dynamic pressure generating grooves 47a are formed on the flange 47 of the intermediate form. More specifically, the first dynamic pressure generating grooves 47a and the ring-shaped flat region 47b are simultaneously formed on the flange 47 by, for example, cold pressing. At this time, the axial upper surface of the extraneous portion 48 is also formed.

Although the groove forming step S2 is described as a separate step from the housing forming step S1, the housing forming step S1 and the groove forming step S2 may be carried out at the same time. In other words, the first dynamic pressure generating grooves 47a and the flat region 47b may be formed at the same time as the pressing in the housing forming step S1.

As described above, the bottom surfaces of the first dynamic pressure generating grooves 47a, the axial upper surfaces of the flat region 47b, and the extraneous portion 48 lie in approximately the same plane, that is, are continuous with each other in approximately the same plane. Therefore, it is possible to easily form the first dynamic pressure generating grooves 47a and the flat region 47b at the same time by pressing, thus preventing an increase in the manufacturing cost.

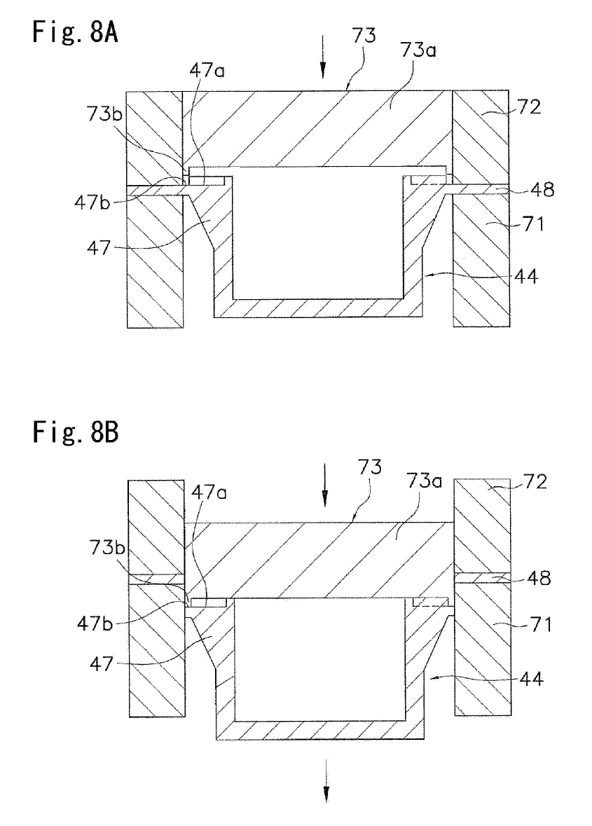

In the cutting step S3, the flange 47 is cut from the intermediate form including the extraneous portion 48 by punching. FIGS. 8A and 8B show how to cut the flange 47 in the cutting step S3. FIG. 8A shows a state before cutting of the flange 47, while FIG. 8B shows a state after the cutting of the flange 47. As shown in FIGS. 8A and 8B, the flange 47 is cut by punching using a hollow support (corresponding to a first jig) 71, a stripper (corresponding to a second jig) 72, and a punch (corresponding to a cutting tool) 73 in the cutting step S3.

First, the intermediate form with the first dynamic pressure generating grooves 47a formed thereon is placed on the support 71. The hollow of the support 71 has a diameter substantially the same as an outer diameter of the flange 47. Therefore, the extraneous portion 48 radially outside the flange 47 is placed on the support 71. The extraneous portion 48 is then pressed against the support 71 by the stripper 72, as shown in FIG. 8A. That is, the extraneous portion 48 is held between the support 71 and the stripper 72.

Then, the punch 73 presses the flat region 47b in the axial direction, as shown in FIG. 8B. Please note that the axial direction is perpendicular to the thrust bearing surface 47d of the flange 47 in the present preferred embodiment. More specifically, the punch 73 includes a hollow punching portion 73a that is cylindrical and a cutting blade 73b projecting from the punching portion 73a in the axial direction. The cutting blade 73b preferably has a shape corresponding to a cutting line. That is, the cutting blade 73b has a shape coincident with the outer periphery of the flat region 47b of the flange 47 when the cutting blade 73b comes into contact with a position in the flat region 47b. The portion with which the cutting blade 73b comes into contact with is cut and forms the boundary between the flat region 47b of the flange 47 and the extraneous portion 48.

When an axially downward load is applied to the punch 73, the cutting blade 73b comes into contact with a portion to be cut in the flat region 47b and presses against that portion. Consequently, a shearing force acts between the flange 47 and the extraneous portion 48 so that the flange 47 and the extraneous portion 48 are separated from each other. In the cutting step S3, the portion to be cut can be held over its entire peripheral length, and cutting is carried out at a portion in the flat region 47b that does not include the first dynamic pressure generating grooves 47a. Therefore, generation of burrs in the first dynamic pressure generating grooves 47a and deforming of the first dynamic pressure generating grooves 47a caused by the cutting are prevented. Thus, it is possible to prevent lowering the bearing performance and make the bearing performance more stable.

Moreover, the axial upper surfaces of the flat region 47band extraneous portion 48 lie in approximately the same plane as the bottom surfaces of the first dynamic pressure generating grooves 47a. Therefore, even if burrs are generated, the burrs do not reach a height of the raised portions 47f . Thus, it is possible to prevent the supply of lubricating fluid and lubrication by the lubricating fluid from being interrupted, so that lowering of the bearing characteristics can be prevented.

A portion of the outer side surface of the flange 47, which extends from the outer peripheral edge of the flat region 47b, has a surface roughness larger than the raised portions 47f on the thrust bearing surface because the portion that extends from the outer peripheral edge of the flat region 47b is formed by cutting.

In accordance with the manufacturing method described above, the bearing housing 44 is obtained.

In accordance with the manufacturing method of the present preferred embodiment, a fluid dynamic bearing 40 can be obtained in which generation of burrs in the first dynamic pressure generating grooves 47a and deforming of the first dynamic pressure generating grooves 47a in the punching step can be prevented.

Moreover, in the spindle motor including the fluid dynamic bearing 40 and the disk drive including the spindle motor, it is possible to prevent generating burrs in the dynamic pressure generating grooves and deforming of the dynamic pressure generating grooves, as compared with conventional fluid dynamic bearings. Thus, lowering of the bearing performance can be prevented and the bearing performance can be made more stable. Accordingly, it is possible to prevent lowering of a driving performance of the disk drive and achieve a more stable driving performance.

### Second Preferred Embodiment

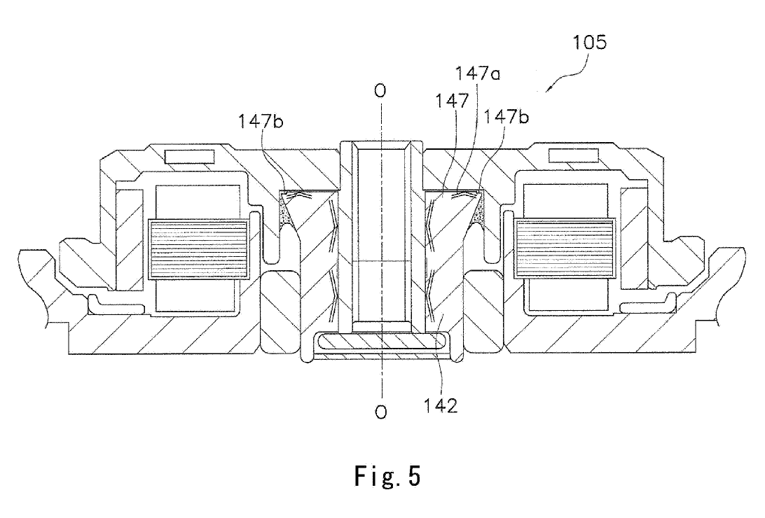

The bearing housing 44 and the sleeve 42 may be unitary and formed of a single component, although they are formed as separate components from each other in the first preferred embodiment. FIG. 5 is a vertical cross-sectional view of a spindle motor 105 according to a second preferred embodiment of the present invention. Differences between the present preferred embodiment and the first preferred embodiment are now described.

As shown in FIG. 5, a sleeve 142 of the spindle motor 105 includes a ring-shaped flange 147 at an axial upper end of the sleeve 142. The flange 147 has a plurality of first dynamic pressure generating grooves 147a and a flat region 147b formed on an axial upper surface thereof. The flat region 147b is ring-shaped. The spindle motor 105 of the present preferred embodiment operates in the same manner as the spindle motor of the first preferred embodiment and has the same effects as those obtained in the first preferred embodiment.

### Third Preferred Embodiment

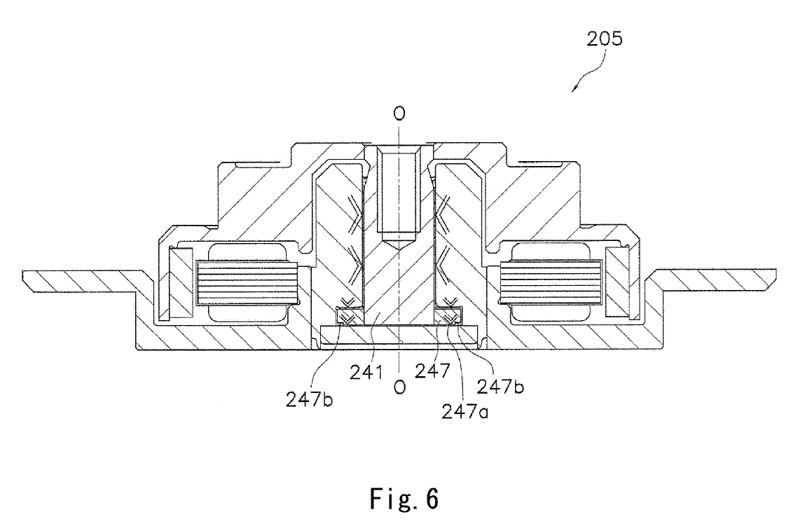

The thrust dynamic bearing portion can be arranged on a lower side of a spindle motor in the axial direction, although the thrust dynamic bearing portion is arranged on an upper side in the first and second preferred embodiments. FIG. 6 is a vertical cross-sectional view of a spindle motor 205 according to a third preferred embodiment of the present invention. Differences between the present preferred embodiment and the first and second preferred embodiments are now described.

As shown in FIG. 6, a thrust plate 247 (serving as a thrust bearing surface), that is ring-shaped, is arranged at an axial lower end of a shaft 241 in the spindle motor 205. The thrust plate 247 is inserted and secured to the end of the shaft 241. On an axial lower surface of the thrust plate 247 are formed a plurality of first dynamic pressure generating grooves 247a and a flat region 247b. The flat region 247b is ring-shaped. The spindle motor 205 operates in the same manner as the spindle motors of the first and second preferred embodiments and can have the same effects as those obtained in the first and second preferred embodiments. Alternatively, the first dynamic pressure generating grooves and the flat region may be formed on an axial upper surface of the thrust plate 247.

In the aforementioned preferred embodiments, the sleeve is described as an exemplary stationary member, for example. However, the present invention is not limited thereto. What is described as a stationary member can be formed as a rotary member and vice versa. The fluid dynamic bearing of the preferred embodiments of the present invention can be applied to various types of fluid dynamic bearings and can achieve the same advantageous effects.

The aforementioned manufacturing method of the bearing housing 44 corresponds to the fluid dynamic bearing 40 of the first preferred embodiment. However, manufacturing methods of the fluid dynamic bearings of the second and third preferred embodiments can provide the same effects.

Although the tube 45 and the flange 47 of the bearing housing 44 are integrally formed with each other in the first preferred embodiment, they may be formed as separate components. In this case, a ring-shaped flange 47 is fitted and secured to an outer peripheral surface of the bearing housing.

Although the sleeve 142 and the flange 147 are integrally formed with each other in the second preferred embodiment, they may be formed separately. In this case, the flange 147 is fitted and secured to an outer peripheral surface of the sleeve 142.

Although the shaft 241 and the thrust plate 247 are formed as separate components from each other in the third preferred embodiment, they may be integrally formed with each other.

In the aforementioned manufacturing method of the bearing housing 44, the punch 73 is described as including a punching portion 73a and a cutting blade 73 arranged at a right angle with respect to the punching portion 73a. However, the shape of the punch 73 is not limited thereto. For example, the punch 73 may include a cylindrical punching portion and a tube-shaped cutting blade that projects from the outer peripheral edge of the punching portion. The cutting blade is at an angle with respect to the axial direction, i.e., a direction perpendicular to the thrust bearing surface. In this case, a bearing housing can be formed in which the outer side surface of the flange extending from the flat region is inclined with respect to the direction perpendicular to the thrust bearing surface by the same angle of the inclination angle as the cutting blade.

In the aforementioned manufacturing method of the bearing housing 44, the punch 73 includes components that are integrally formed. However, a punch in which a body and a cutting blade are formed as separate components from a shaft portion may be used. In this case, the punching portion is attached to an outer circumference of the shaft portion to be movable in the axial direction. Therefore, it is possible to more surely align the bearing housing and the punch, more specifically, the flat region of the bearing housing and the cutting blade of the punch with respect to each other.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A fluid dynamic bearing arranged to support a rotating member in a rotatable manner around a rotation axis relative to a stationary member, the fluid dynamic bearing comprising:
a first member having a first bearing surface arranged around the rotation axis and extending away from the rotation axis;
a second member having a second bearing surface facing the first bearing surface with a gap interposed therebetween; and
lubricating fluid retained in the gap; wherein
a rim of the second bearing surface has a larger surface roughness than a surface roughness of another portion of the second bearing surface; and
at least one of the first and second bearing surfaces includes a depression at an outer periphery thereof, a radial position of which corresponds to the rim of the second bearing surface, thereby enlarging the gap in a direction away from the rotation axis.

2. A fluid dynamic bearing supporting a rotating member in a rotatable manner relative to a stationary member, the fluid dynamic bearing comprising:
a first member including a substantially cylindrical sleeve;
a second member including a shaft arranged inside the sleeve, the shaft being rotatable relative to the sleeve;
a radial dynamic bearing and a thrust dynamic bearing supporting one of the first and second members in a rotatable manner relative to the other of the first and second members; and
lubricating fluid retained in the radial dynamic bearing and the thrust dynamic bearing; wherein
the first and second members respectively have thrust bearing surfaces defining the thrust dynamic bearing, the thrust bearing surfaces being opposed to each other with a thrust gap interposed therebetween;
one of the thrust bearing surfaces has a plurality of dynamic pressure generating grooves provided thereon, the dynamic pressure generating grooves generating a dynamic pressure of the lubricating fluid in the thrust gap during relative rotation of one of the first and second members to the other; and
a flat region is arranged at and along an outer peripheral edge of the one of the thrust bearing surfaces, a distance between the thrust bearing surfaces being larger in the flat region than in a remaining region of the one of the thrust bearing surfaces.

3. A fluid dynamic bearing according to claim 2, wherein the flat region is continuous with bottom surfaces of the dynamic pressure generating grooves and located in approximately the same plane.

4. A fluid dynamic bearing according to claim 2, wherein the one of the thrust bearing surfaces is arranged at an open end of a hollow cylindrical member, the hollow cylindrical member also having a closed end.

5. A fluid dynamic bearing according to claim 2, wherein a projection is arranged on the one of the thrust bearing surfaces at a portion adjacent a shaft side of the dynamic pressure generating grooves, the projection projecting from bottom surfaces of the dynamic pressure generating grooves.

6. A fluid dynamic bearing according to claim 5, wherein
the one of the thrust bearing surfaces has a plurality of raised portions adjacent to the dynamic pressure generating grooves, respectively; and
the projection is continuous with the raised portions and lies in approximately the same plane as the raised portions.

7. A fluid dynamic bearing according to claim 2, wherein the dynamic pressure generating grooves include pressed portions.

8. A spindle motor comprising:
the fluid dynamic bearing of claim 2;
a housing, a stator secured to the housing, and a stator coil wound around the stator; and
a rotor including a rotor magnet facing the stator; wherein
the rotor is the rotating member and the housing is the stationary member, and the fluid dynamic bearing supports the rotor in a rotatable manner relative to the housing.

9. A disk drive including a disk-shaped storage medium, comprising:
the spindle motor of claim 8;
a magnetic head arranged to record and/or read information on/from the disk-shaped storage medium; and
a moving unit arranged to move the magnetic head relative to the disk-shaped storage medium; wherein
the spindle motor is arranged to rotate the disk-shaped recording medium.

10. A manufacturing method of a dynamic bearing member having a thrust bearing surface, the method comprising the steps of:
forming a plurality of dynamic pressure generating grooves on the thrust bearing surface;
holding an extraneous portion surrounding an outer peripheral edge of the thrust bearing surface; and
cutting the thrust bearing surface from the extraneous portion by pressing the outer peripheral edge of the thrust bearing surface in a direction that is substantially perpendicular to the thrust bearing surface.

11. A manufacturing method according to claim 10, wherein a flat region is provided at and along the outer peripheral edge of the thrust bearing surface when the dynamic pressure generating grooves are formed, and the step of cutting includes:
pressing against an entire peripheral length of the flat region to cut the thrust bearing surface from the extraneous portion while holding the extraneous portion over an entire peripheral length of the extraneous portion.

12. A manufacturing method according to claim 11, wherein the flat region and bottom surfaces of the dynamic pressure generating grooves are continuous with each other in approximately the same plane, and the step of forming the dynamic pressure generating grooves includes:
pressing the dynamic pressure generating grooves in the thrust bearing surface.

13. A manufacturing method according to claim 11, wherein the steps of holding and cutting the thrust bearing surface include:
holding the extraneous portion between first and second cylindrical jigs in the direction that is substantially perpendicular to the thrust bearing surface; and
pressing the flat region with a cutting tool, wherein the cutting tool is provided inside the second jig and is movable in the direction perpendicular to the thrust bearing surface.

14. A manufacturing method according to claim 10, further comprising:
forming the dynamic bearing member by pressing.

15. A manufacturing method according to claim 10, wherein the steps of holding and cutting the thrust bearing surface include:
holding the extraneous portion between first and second cylindrical jigs in the direction that is substantially perpendicular to the thrust bearing surface; and
pressing a flat region provided at and along the outer peripheral edge of the thrust bearing surface with a cutting tool, wherein the cutting tool is provided inside the second jig and is movable in the direction that is substantially perpendicular to the thrust bearing surface.

16. A manufacturing method according to claim 15, wherein the cutting tool includes a tool body and a cutting blade, the tool body is arranged at an inner side surface of the second jig, and the cutting blade projects from an outer peripheral edge of the tool body in the direction that is substantially perpendicular to the thrust bearing surface.
